(19) United States
(12) Patent Application Publication
(10) Pub. No.: US 2014/0223552 A1
(43) Pub. Date: Aug. 7, 2014

(54) AUTHENTICATION SYSTEM AND METHOD THEREFOR

(71) Applicants: John Petersen, London (GB); Patrick Carroll, London (GB); Jonathan Mark Alford, London (GB); Daniel Thornhill, Ipswich (GB)

(72) Inventors: John Petersen, London (GB); Patrick Carroll, London (GB); Jonathan Mark Alford, London (GB); Daniel Thornhill, Ipswich (GB)

(21) Appl. No.: 14/232,775

(22) PCT Filed: Jul. 12, 2012
(86) PCT No.: PCT/GB2012/051656

§ 371 Date: Feb. 28, 2014

(30) Foreign Application Priority Data
Jul. 15, 2011 (GB) 1112293.4

(51) Int. Cl. G06F 21/31

(52) U.S. Cl. CPC G06F 21/313
USPC 726/19

(57) ABSTRACT

An authentication system is disclosed. The system comprises means for receiving an authentication request associated with the transaction wherein the request comprises data identifying a communication device associated with a user authorised to perform the transaction; means for sending a Mobile Application Part, MAP, protocol request message in response to the authentication request; means for receiving, in response to the MAP protocol request, data indicative of whether a communication sent to the communication device will be forwarded to a different communication device. The received data indicative of whether a communication sent to the communication device will be forwarded to a different communication device is used in determining whether to authenticate the transaction.

### FIELD OF THE INVENTION

This invention relates to a method and system for detecting call forwarding of mobile telephones. More particularly, this invention relates to detecting call forwarding of a mobile telephone used for user authentication in electronic commerce and in particular with an internet banking or mobile banking application.

### BACKGROUND OF THE INVENTION

With the increase in both the volume and sophistication of fraudulent attacks against electronic commerce and in particular internet banking applications, many banks have been forced to adopt greater security protection for these applications.

One such form of protection, known as Out-of-Band (OOB) Authentication, requires the authentication of the user, and optionally the verification of the transaction content, to be performed on an OOB channel, as distinct to the Internet channel on which the transaction is being transmitted. The OOB channel is typically a mobile or landline telephone channel, utilising either voice or SMS protocols. The OOB authentication is typically performed automatically by telecommunications based software operated by the bank, such as an outbound Interactive Voice Response (IVR) system.

Only telephone numbers registered with the bank can be selected, thus providing an additional authentication step in the authentication process. The authentication process usually requires some form of knowledge such as a username and password combination to initially access the system. Typically these solutions will provide the user with a onetime-pass-code (OTP) with which to complete the transaction.

However, a person with ill intent, such as a fraudster or hacker, may try to compromise this form of strong authentication, by using techniques to gain effective control of registered mobile telephones and thus the access to the OTP required for completion of a (fraudulent) online transaction. This may be done by identifying the Mobile Network Operator (MNO) the user subscribes to, impersonating the subscriber to the MNO and requesting from the MNO that all calls to the subscriber's number are forwarded to another number associated with the fraudster's telephone.

Accordingly, the fraudster can therefore access the user's online banking account, using previously obtained knowledge information such as username and password combination, perform a transaction to obtain funds, as well as possibly authenticating and completing a transaction using the genuine user's mobile telephone number. The fraudster simply selects that telephone to authenticate, and the call is automatically forwarded to the fraudster's telephone and the transaction then authorised. The genuine subscriber will only be aware of the telephone being forwarded by speaking to the MNO concerned to query why calls are not being received. By this stage, however, the fraud has been perpetrated and the funds stolen.

One known method for attempting to identify calls to a telephone where call-forwarding is activated is through Integrated Services Digital Network (ISDN) signalling using ISDN cards that support this level of functionality. ISDN allows for the simultaneous transmission of voice, data, and other services.

However, this method has a number of limitations, not least being its dependence on each MNO actually distributing this information over their networks. Further, even if the information is present on the network, it still requires specialised equipment to access it.

### SUMMARY OF THE INVENTION

The invention is defined in appended claims to which reference should now be made. Rather than using ISDN signalling information within the actual connection of the telephone call itself, embodiments of the invention seek to address the above mentioned problems by making a completely independent Mobile Application Part (MAP) protocol request to a Home Location Register (HLR) of the subscriber's MNO. This request is performed before any attempt is made to connect to the mobile telephone and is not reliant on ISDN signalling of any type. The method used by fraudsters results in what is known as Call Forward Unconditional (CFU) status. Contained within the HLR is an indicator showing this status is active along with the actual call-termination telephone number. This information is always present within the MNO's HLR regardless of whether it is accessible via ISDN signalling. Usually, the authentication request is received from an application such as an internet banking application for performing a funds transfer.

Having identified that a mobile telephone is set to CFU, a mobile telephone based strong authentication system may then prevent a successful authentication and therefore also prevent authorisation occurring using the mobile telephone number in question. The system may also prevent or avoid the transmission of an authentication code to the mobile telephone number or may prevent the transmission of authentication and authorisation code to the mobile telephone number.

According to one aspect of the present invention a system for authenticating a transaction comprises means for receiving an authentication request wherein the request comprises data identifying a communication device associated with a user authorised to perform the transaction; means for sending a Mobile Application Part, MAP, protocol request message in response to the authentication request; means for receiving, in response to the MAP protocol request, data indicative of whether a communication sent to the communication device will be forwarded to a different communication device; wherein the request is authorise the request in dependence upon the received data.

Usually, the transaction is authenticated by an authentication server. However, the authentication server may also perform authorisation of the transaction, but alternatively, a separate authentication server and a separate authorisation server may be provided.

Usually, the means for receiving an authentication request is a wireless or wired connection such as an internet connection. The means for sending the MAP request is usually a server communicatively coupled to a location database, such as a Home Location Register database. The receiving means is usually a server communicatively coupled to the location database.

### BRIEF DESCRIPTION OF THE DRAWINGS

An embodiment of the invention will now be described, by way of example only, and with reference to the accompanying drawings, in which:

FIG. 1 is a schematic diagram showing the main functional components of a system embodying the invention; and

FIG. 2 is a flow diagram showing the main steps performed by an embodiment of the invention.

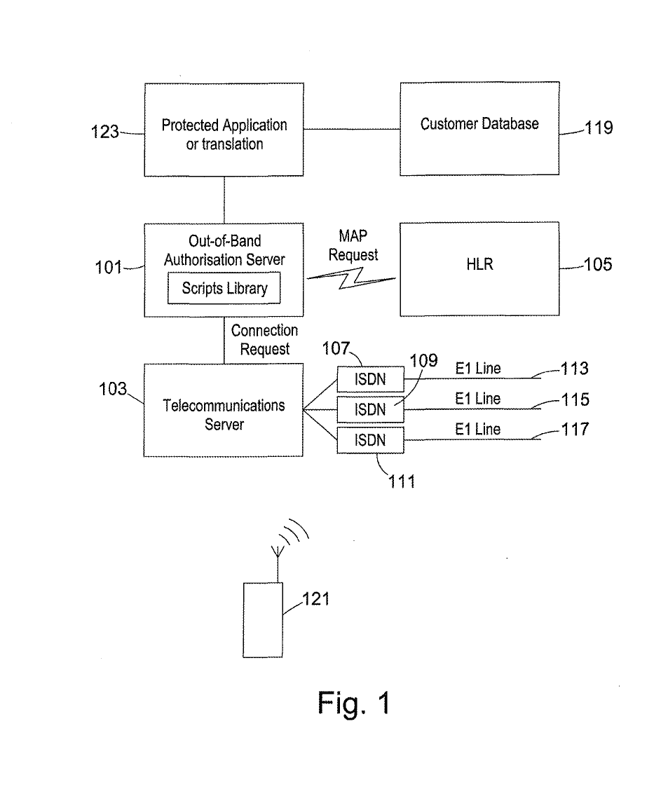

Referring now to FIG. 1, this is a schematic diagram of the major components of an authentication system embodying the invention. The system comprises an authentication or authorisation server, or both 101 which is communicatively coupled to a telecommunication server 103. The system may include a remote Home Location Register (HLR) 105 which may be used to detect the Call-forward Unconditional state of one or more mobile telephones. An HLR database is held by every mobile network provider and comprises information on that provider's permanent and visiting subscribers. The Home Location Register may be stored in a memory such as a random access memory or other memory. The Home Location Register is usually stored on a server. The HLR 105 is communicatively coupled to the authorisation server 101. This is usually by wireless means but a wired connection, such as a dedicated fibre link, may also be used.

The telecommunications server 103 controls the connection to a user's telephone 121 shown in FIG. 1. The telecommunication server 103 may connect and disconnect a call, play voice scripts, recognise dual-tone multi-frequency (DTMF) replies, pass voice responses to speech recognition or voice verification services, and communicate such responses back to the authorisation server 101 for action. The telecommunications server 103 may be arranged to connect to the user's telephone via one or more ISDN cards 107, 109, 111. The ISDN cards may communicate with a user's telephone via a carrier or telecommunications provider using dedicated E1 voice or data lines or using both voice and data lines, 113, 115, 117. A customer database 119 may also be provided. The customer database is usually provided by a financial services organisation. The financial services organisation 119 may be a bank, or building society, or credit agency, for example.

The database 119 is usually stored on a server. The customer database 119 is usually communicatively coupled to a protected application 123. However, the protected application does not necessarily have to communicate directly with the customer database provided by the financial services organisation. For example, the authorisation server 101 may be arranged to receive a telephone number from the financial services organisation by sending details of the attempted transaction to the financial services organisation.

The database 119 usually stores data of a plurality of customers registered with the financial services organisation. The data may comprise a unique identifier associated with a landline or mobile telephone that the customer wishes to use for authentication. Usually, the identifier is telephone number such as a Mobile Station International Subscriber Directory Number (MSISDN). Usually, each telephone number is associated with a customer identifier. In this way, when a customer attempts to use a protected application, the identity of the customer can be determined, and the registered telephone number associated with a particular customer identifier can be determined. The telephone numbers do not necessarily have to be stored on the customer database 119, but can be stored in any storage means, provided the storage means is communicatively coupled to the authorisation server.

Preferably, the telecommunications server 103 or authorisation server 101 does not store the telephone number associated with a user registered with the financial services organisation. This is advantageous in that the amount of data which needs to be stored on the authorisation server is minimal. It also means that potentially confidential data does not need to be unnecessarily passed to 3^{rd} parties outside the financial services organisation.

Also shown in FIG. 1 is the protected application or transaction, 123 referred to above. The protected application may be an application supporting an internet banking funds transfer. The protected application or transaction is communicatively coupled to the authorisation server 101, usually via wireless means but a wired connection, such as a dedicated fibre link, may also be used. Similarly, the protected application or transaction is also communicatively coupled to the customer database 119.

The protected application 123 may access the customer database 119 held by the financial services organisation. Usually the protected application 123 accesses the financial services database via an application programming interface, API. The API may be a web API which allows the financial services organisation's customer database to be accessed over the internet.

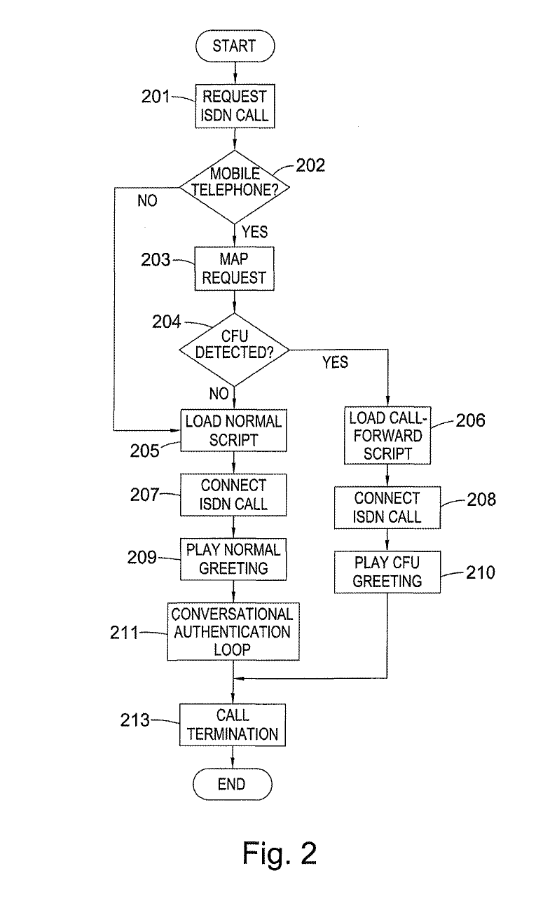

The main steps performed by an embodiment of the invention will now be described referring to the flow diagram shown in FIG. 2 of the drawings. This shows a typical process flow for an OOB authentication solution according to an embodiment of the invention which detects the CFU state within a mobile telephone being used for authentication purposes. This assumes that a user has previously registered with the financial services organisation 119 a telephone number associated with a landline or mobile telephone, they wish to use for authentication.

A user initially attempts to use a protected application. For example, a user may log on to an internet banking website using a username and a password. The user may request that a transaction is carried out. In response to the transaction request, the protected application 123 determines the telephone number of the user registered or authorised to use the application by sending a request to the customer database 119 to extract from the database the registered telephone which is associated with the user registered to use the protected application. Details of the requested transaction may be sent to allow the telephone number to be extracted but alternatively, a user name or other identifier may be sent to allow lookup.

At step 201, the protected application or transaction 123, such as an Internet banking funds transfer, sends an authorisation request to the authorisation server 101.

As part of the authorisation request, the protected application 123 passes the determined telephone number associated with the user registered to use the protected application to the authorisation server 101 via a standard API.

At step 202, the authorisation server 101 determines whether the telephone number to be authenticated is associated with a mobile telephone or a landline. The authorisation server may determine whether the telephone number is associated with a mobile telephone or landline may be by using an attribute within the financial services organisation's customer database. The attribute may be used to distinguish telephone numbers associated with mobile telephones from telephone numbers associated with landlines. The response sent from the financial services organisation to the protected application 123 may include this attribute which distinguishes a mobile telephone number from a landline telephone number. If the telephone number is determined to be a landline telephone number at step 202, then steps 203 to and 204 are not performed, and no determination of the status of the CFU is made. Instead, the telecommunications server, at step 205 loads the normal script, and the remaining steps 207, 209, 211, and 213 are described in further detail below. Alternatively, if it the telephone number is erroneously identified as a mobile an error message is received from the HLR lookup and the process continues normally at step 205, as described below.

At step 203, if the authorisation server 101 has determined that the selected authentication device is a mobile telephone, the authorisation server 101 sends a Mobile Application Part (MAP) request to the Home Location Register 105. The Home Location Register may be externally provided by a third party. An extract from a Home Location Register used by embodiments of the invention is shown below in table 1.

TABLE 1
An extract of a database comprising HLR data.
HLR data

| | CFU/CFnReachable | Forwarding |
|---|---|---|
| Telephone number | Active | Telephone number |
| 00 44 7981 475 722 | Yes | 00 44 9523 888 868 |
| 00 44 7981 234 634 | No | — |
| 00 44 7981 967 138 | Yes | 00 44 9523 777 869 |

The authorisation server 101 searches the Home Location Register using the mobile telephone number as a lookup key. For example, if the authorisation server 101 has determined that the telephone number of the mobile telephone is 00 44 7981 475 722, it searches the HLR database using the telephone number associated with a user authorised to carry out the transaction. In this example, the authorisation server searches the HLR database for a telephone number matching the telephone number 00 44 7981 475 722. In table 1, there is a single telephone number which matches the telephone number 00 44 7981 475 722. The authorisation server 101 then searches for HLR data associated with matching telephone number. The authorisation server 101 determines the call forward status in the Home Location Register database as well as the telephone number which a call is forwarded to, if present.

The MAP request returns to the authorisation server 101 the CFU/CFnReachable information, which shows whether Call Forwarding is active for that telephone number and if so, the number being forwarded to.

In this example, the HLR data associated with the telephone number 00 44 7981 475 722 shows that call forwarding is activated. Further, the data also shows the telephone number being forwarded to is 00 44 9523 888 868. In this way, the information indicating whether call forwarding is activated is passed from the HLR to the authorisation server 101. Preferably, the information includes the telephone number being forwarded to.

At step 204 the authorisation server 101 determines, based on the result of the MAP call, whether to perform the normal processing script or to perform the CFU processing script. If the authorisation server 101 receives data indicative that call forwarding is active, then it instructs the telecommunications server 103 to retrieve the appropriate call forward script from a memory. The scripts are stored in a memory on the telecommunication server. However, it is the authorisation server 101 that instructs the telecommunications server 103 which script should be retrieved from the memory and what actions the telecommunications server should perform based on each response received from the user.

The telecommunications server 101 then loads the call forward script at step 206. At step 208, the server 103 then connects the call to the previously determined registered telephone number of the user authorised to use the service via an ISDN card 107, 109, 109 and communications line 113, 115, 117. In the previous example, the telephone number being authenticated is 00 44 7981 475 722 and therefore, the call is connected to the mobile device associated with telephone number 00 44 7981 475 722.

As the authorisation server 101 has previously determined that call forward is active, at step 210 the telecommunications server 103 plays a message stating that authentication is not possible, and also preferably stating this is due to call forwarding being detected. The message may also instruct the user to contact the bank. At this point the telecommunication server terminates the call at step 212. The authentication will thus fail and the transaction will usually not be authorised. However, the final decision as to whether a transaction will be authorised will usually be made by a risk engine which may be provided by or for a financial services organisation. The risk engine will usually take into account other factors, such as the size of the requested transaction, whether a user has previously performed a similar transaction, in determining whether to authorise a transaction, and therefore, there may be instances in which, even if call forwarding is detected, that the transaction may still be authorised.

At step 204, if the authorisation server 101 determines that call forwarding is not detected from the MAP call, then the authorisation server 101 instructs the telecommunications server 103 to load from the memory a script indicating that secondary authentication will occur. At step 205, the telecommunications server 103 loads the script. At step 207, the telecommunications server then connects the call via one of the ISDN cards 107, 109, 111 to a line 113, 115, 117 and thus connects the telecommunications server 103 to the telephone associated with the telephone number being authenticated. At step 209 a greeting is played indicating that secondary authentication will be performed. At step 211, secondary authentication occurs. This may comprise the authorisation server 101 sending a one time pass code to the registered telephone number of the user authorised to use the service. The user enters the one time pass code to user the service. In this way, the user is authenticated and the call is terminated at step 212.

1-50. (canceled)

51. A method for authenticating a transaction within a transaction processing system, the method comprising:
receiving an authentication request associated with the transaction, wherein the request comprises data identifying a communication device associated with a user authorised to perform the transaction;
sending a Mobile Application Part, MAP, protocol request message to a home location register within a separate mobile communication network in response to the authentication request; and
receiving from the home location register, in response to the MAP protocol request, data indicative of whether a communication sent to the communication device will be forwarded to a different communication device;
wherein the received data indicative of whether a communication sent to the communication device will be forwarded to a different communication device is used in determining whether to authenticate the transaction.

52. A method according to claim 51, further comprising authenticating the transaction in dependence upon the received data.

53. A method according to claim 51, further comprising sending a communication to the communication device associated with the user authorised to perform the transaction in dependence upon the received data.

54. A method according to claim 53, wherein the communication comprises a code for authenticating the transaction.

55. A method according to claim 53, wherein the communication is a telephone call or message, in particular a Short Message Service, SMS, text message or Multimedia Message Service, MMS, message.

56. A method according to claim 51, wherein the MAP protocol request comprises the data identifying the communication device associated with the user authorised to perform the transaction.

57. A method according to claim 51, wherein the data identifying a communication device is a telephone number associated with a user authorised to perform the transaction and the communication device is a telephone.

58. A method according to claim 57, further comprising determining whether the telephone number is associated with a mobile telephone or a landline telephone and determining whether to send the MAP protocol request message in dependence upon the result of the determination.

59. A method according to claim 57, further comprising determining a telephone number in the home location register which matches the telephone number associated with the user authorised to use the protected application.

60. A method according to claim 59, further comprising determining the call forward status associated with the telephone number in the home location register which matches the telephone number of the user authorised to perform the transaction;
wherein the transaction is only authorised if the authentication server determines that the call forward status associated with the telephone number in the home location register which matches the telephone number of the user authorised to use the protected application is not active.

61. A method according to claim 60, wherein if it is determined that call forwarding is active, the method further comprises playing a script indicating that authentication is not possible; and
wherein if it is determined that call forwarding is not active, the method further comprises playing a script indicating that authentication will occur.

62. A method according to claim 51, wherein the received data comprises call forward unconditional data.

63. An authentication server for authenticating a transaction within a transaction processing system, the authentication server being arranged to:
receive an authentication request associated with the transaction, wherein the request comprises data identifying a communication device associated with a user authorised to perform the transaction;
send a Mobile Application Part, MAP, protocol request message to a home location register within a separate mobile communication network in response to the authentication request; and
receive from the home location register, in response to the MAP protocol request, data indicative of whether a communication sent to the communication device will be forwarded to a different communication device;
wherein the received data indicative of whether a communication sent to the communication device will be forwarded to a different communication device is used in determining whether to authenticate the transaction.

64. An authentication system comprising:
an authentication server for authenticating a transaction within a transaction processing system, the authentication server being arranged to:
receive an authentication request associated with the transaction, wherein the request comprises data identifying a communication device associated with a user authorised to perform the transaction;
send a Mobile Application Part, MAP, protocol request message to a home location register within a separate mobile communication network in response to the authentication request; and
receive from the home location register, in response to the MAP protocol request, data indicative of whether a communication sent to the communication device will be forwarded to a different communication device;
wherein the received data indicative of whether a communication sent to the communication device will be forwarded to a different communication device is used in determining whether to authenticate the transaction; and
a communications server arranged to send a communication to the communication device associated with the user authorised to perform the transaction in dependence on the received data.

65. An authentication system comprising:
an authentication server for authenticating a transaction within a transaction processing system, the authentication server being arranged to:
receive an authentication request associated with the transaction, wherein the request comprises data identifying a communication device associated with a user authorised to perform the transaction;
send a Mobile Application Part, MAP, protocol request message to a home location register within a separate mobile communication network in response to the authentication request; and
receive from the home location register, in response to the MAP protocol request, data indicative of whether a communication sent to the communication device will be forwarded to a different communication device;
wherein the received data indicative of whether a communication sent to the communication device will be forwarded to a different communication device is used in determining whether to authenticate the transaction; and
a communications server arranged to send a communication to the communication device associated with the user authorised to perform the transaction in dependence on the received data;
wherein the authentication system is arranged to:
receive an authentication request associated with the transaction, wherein the request comprises data identifying a communication device associated with a user authorised to perform the transaction;
send a Mobile Application Part, MAP, protocol request message to a home location register within a separate mobile communication network in response to the authentication request; and
receive from the home location register, in response to the MAP protocol request, data indicative of whether a communication sent to the communication device will be forwarded to a different communication device;
wherein the received data indicative of whether a communication sent to the communication device will be forwarded to a different communication device is used in determining whether to authenticate the transaction.
